(19) United States
(12) Patent Application Publication
(10) Pub. No.: US 2012/0021119 A1
(43) Pub. Date: Jan. 26, 2012

(54) CURRY SEASONING AND ITS PREPARATION PROCESS

(76) Inventor: Guangjun ZHAO, Tong Hua (CN)

(21) Appl. No.: 13/004,830

(22) Filed: Jan. 11, 2011

(30) Foreign Application Priority Data
Jul. 23, 2010 (CN) 201010234626.0

(51) Int. Cl. A23L 1/221

(52) U.S. Cl. 426/650

(57) ABSTRACT

A curry seasoning produced by a process in which star anise is fried at a high temperature before being incorporated into the curry seasoning in order to reduce side effects caused by ingesting star anise.

### FIELD OF THE INVENTION

The invention relates to a curry seasoning and its preparation process.

### BACKGROUND

A seasoning is an additive material for flavoring food, which is frequently used for cooking in daily life and various professional occasions, inextricably linked with people's daily life.

With economic development and the increasing pace of life, fast food is becoming more and more people's choice due to its rapidness, which shows a continued trend of development.

Among the various seasonings, curry seasoning is especially widely and frequently used in fast food.

Currently, there are many forms of curry seasonings including block type, powder type, cream type, and the like. However, most of the curry seasonings are prepared by simply mixing the natural spices, coarsely pulverizing, and then adding seasonings such as edible salt, monosodium glutamate for a final product with a simple packaging, which results in a series of quality problems of harsh appearance, substandard sanitation, and unbalanced nutrition.

As a seasoning for fast food closely linked with people's lives, curry seasoning relates to not only the taste and quality of the food, also the food health and hygiene and safety, which is receiving more and more attention.

### SUMMARY

The objective of the invention is to provide a curry seasoning by a scientific selection of materials and hot working technology to incorporate into the formula with various vegetable nutrition components and the essential trace elements which cannot be synthesized by human body. In this way, the curry seasoning prepared by the invention has a good taste, rich and balanced nutrition, and good sanitation, and satisfies the standards according to the GMP national standard for food production.

The components of the formula of the invention are as follows:

schisandrae fruit 1-3%, star anise 1-3%, coriander 0.5-1.5%, brassica alba boiss 0.5-1.5%, celery seed 0.5-1.5%, cumin 0.5-1.5%, white pepper 0.5-1.5%, black pepper 0.5-1.5%, onion 0.5-1.5%, dried tangerine peel 0.5-1.5%, semen trigonellae 0.5-1.5%, myristica fragrans houttuyn 0.5-1.5%, cinnamomum wilsonii gamble 0.5-1.5%, cardamon 0.5-1.5%, capsicum 0.5-1.5%, flos caryophylli 0.5-1.5%, rhizoma zingiberis 0.5-1.5%, cuminum cyminum 0.5-1.5%, fructus foeniculi 0.5-1.5%, allium sativum 0.5-1.5%, allspice 0.5-1.5%, thymus 0.5-1.5%, mustard 0.5-1.5%, pericarpium zanthoxyli 1-3%, radix angelicae dahuricae 0.5-1.5%, turmeric 25-35%, lentinus edodes 0.5-1.5%, hericium erinaceus 0.5-1.5%, ganoderma lucidum 0.5-1.5%, fructus Jujubae date 0.5-1.5%, longan 0.5-1.5%, cynamorlum herba cistanches 0.5-1.5%, morinda officinalis 0.5-1.5%, prepared fleeceflower root 0.5-1.5%, carrot 0.5-1.5%, boxthorn fruit 0.5-1.5%, flos chrysanthemi indici 0.5-1.5%, rhizoma batatatis 0.5-1.5%, celery seed 0.5-1.5%, vegetable oil 2.5-3.5%, wheat flour 0.5-1.5%, disodium 5′-inosinate 0.5-1.5%, glycerol monostearate 2-4%, tryptophan 0.5-1.5%, defatted milk powder 0.5-1.5%, coconut powder 0.5-1.5%, honey 0.5-1.5%, glucose 0.5-1.5%, apple paste 0.5-1.5%, hydrolyzed vegetable protein 0.5-1.5%, L-lysine 0.5-1.5%, taurine 0.5-1.5%, peppermint 0.5-1.5%, multivariant high calcium 0.5-1.5%, ferrous gluconate 0.3-0.7%, zinc gluconate 0.3-0.7%, soybean lecithin 0.5-1.5%, red grape wine 0.5-1.5%, tyrosine 0.3-0.7%, methionine 0.3-0.7%, glycine 0.3-0.7%,

provided that, after a final product is prepared using the raw materials in the above blending weight ratios, the sum of all components should be 100% by weight.

The method of producing a curry seasoning of the invention is as follows:

(1) the star anise is fried in an automatic frying pan at 155° C. for 23 minutes, and then taken out for reserving;

(2) schisandrae fruit, coriander, brassica alba boiss, celery seed, cumin, white pepper, black pepper, onion, dried tangerine peel, semen trigonellae, myristica fragrans houttuyn, cinnamomum wilsonii gamble, cardamon, capsicum, flos caryophylli, rhizoma zingiberis, cuminum cyminum, fructus foeniculi, allium sativum, allspice, thymus, mustard, pericarpium zanthoxyli, radix angelicae dahuricae, turmeric, lentinus edodes, hericium erinaceus, ganoderma lucidum, fructus Jujubae date, longan, cynamorlum herba cistanches, morinda officinalis, prepared fleeceflower root, carrot, boxthorn fruit, flos chrysanthemi indici, rhizoma batatatis, celery, peppermint, wheat flour, gardenia jasminoides, and fructus cnidii selinum are added into an automatic drying machine and dried at 110° C. for 30 minutes, and then taken out, placed into an automatic pulverizer together with the fried star anise and crushed into 250-300 mesh powders for reserving;

(3) the vegetable oil is pored into a jacketed pan and heated to 100° C.; then the reserved schisandrae fruit, coriander, brassica alba boiss, celery seed, cumin, white pepper, black pepper, onion, dried tangerine peel, semen trigonellae, myristica fragrans houttuyn, cinnamomum wilsonii gamble, cardamon, capsicum, flos caryophylli, rhizoma zingiberis, cuminum cyminum, fructus foeniculi, allium sativum, allspice, thymus, mustard, pericarpium zanthoxyli, radix angelicae dahuricae, turmeric, lentinus edodes, hericium erinaceus, ganoderma lucidum, fructus Jujubae date, longan, cynamorlum herba cistanches, morinda officinalis, prepared fleeceflower root, carrot, boxthorn fruit, flos chrysanthemi indici, rhizoma batatatis, celery, peppermint, wheat flour, gardenia jasminoides, and fructus cnidii selinum together with the fried star anise are added, and fried for 15 minutes; after the heating is ceased and the temperature is naturally cooled to 30° C., white granulated sugar, edible salt, sodium glutamate, disodium 5′-inosinate, citric acid, glycerol monostearate, tryptophan, defatted milk powder, coconut powder, honey, glucose, apple paste, hydrolyzed vegetable protein, L-lysine, taurine, multivariant high calcium, ferrous gluconate, zinc gluconate, soybean lecithin, red grape wine, tyrosine, methionine, glycine are added into the pan, stirred for 15 minutes, and then taken out, briquetted, packaged for the final product.

### DESCRIPTION

In the conventional process, the star anise is incorporated into the formula immediately after being crushed, and there may occur side effects such as dizziness, headache, nausea, and vomit in many consumers after eating. A frying step is added into the preparation process of the invention, for the purpose of eliminating the chemical component of safrole contained in the star anise by high temperature treatment, thus completely eliminating side effects such as dizziness, headache, nausea, and vomit which occurred when eating the unfried star anise.

The curry seasoning prepared by the invention can be used to cook foods such as curry beef, curry steak, curry chicken, curry meat(fish), curry rice, curry soup, curry roast meat. The expected effect can be obtained by either directly adding the curry seasoning into the above food immediately before taken out of cooking pot, or pouring the heated curry seasoning onto the rice.

The curry seasoning of the invention is characterized by good sanitation, convenience, balanced nutrition, rich in various vegetable nutrition components and the essential trace elements which cannot be synthesized by human body, due to the scientific selection of materials and abundant materials in combination with the effective preparation process; therefore the invention is effective to improve the quality of curried foods, and will have broad social significance and market prospects.

The invention will be further illustrated by the following example.

### Example

The components in the formula of the Example according to the invention are specifically as follows:

schisandrae fruit 20 g, star anise 20 g, coriander 10 g, brassica alba boiss 10 g, celery seed 10 g, cumin 10 g, white pepper 10 g, black pepper 10 g, onion 10 g, dried tangerine peel 10 g, semen trigonellae 10 g, myristica fragrans houttuyn 10 g, cinnamomum wilsonii gamble 10 g, cardamon 10 g, capsicum 10 g, flos caryophylli 10 g, rhizoma zingiberis 10 g, cuminum cyminum 10 g, fructus foeniculi 10 g, allium sativum 10 g, allspice 10 g, thymus 10 g, mustard 10 g, pericarpium zanthoxyli 20 g, radix angelicae dahuricae 10 g, turmeric 300 g, lentinus edodes 10 g, hericium erinaceus 10 g, ganoderma lucidum 10 g, fructus Jujubae date 10 g, longan 10 g, cynamorlum herba cistanches 10 g, morinda officinalis 10 g, prepared fleeceflower root 10 g, carrot 10 g, boxthorn fruit 10 g, flos chrysanthemi indici 10 g, rhizoma batatatis 10 g, celery 10 g, peppermint 10 g, vegetable oil 30 g, wheat flour 10 g, gardenia jasminoides 10 g, fructus cnidii selinum 10 g, white granulated sugar 10 g, edible salt 5 g, sodium glutamate 10 g, citric acid 10 g, disodium 5′-inosinate 10 g, glycerol monostearate 30 g, tryptophan 10 g, defatted milk powder 10 g, coconut powder 10 g, honey 10 g, glucose 10 g, apple paste 10 g, hydrolyzed vegetable protein 10 g, L-lysine 10 g, taurine 10 g, multivariant high calcium 10 g, ferrous gluconate 5 g, zinc gluconate 5 g, soybean lecithin 10 g, red grape wine 10 g, tyrosine 5 g, methionine 5 g, glycine 5 g

The specific producing method in the Example according to the invention is as follows:

(1) The star anise is fried in an automatic frying pan at 155° C. for 23 minutes, and then taken out for reserving;

(2) schisandrae fruit, coriander, brassica alba boiss, celery seed, cumin, white pepper, black pepper, onion, dried tangerine peel, semen trigonellae, myristica fragrans houttuyn, cinnamomum wilsonii gamble, cardamon, capsicum, flos caryophylli, rhizoma zingiberis, cuminum cyminum, fructus foeniculi, allium sativum, allspice, thymus, mustard, pericarpium zanthoxyli, radix angelicae dahuricae, turmeric, lentinus edodes, hericium erinaceus, ganoderma lucidum, fructus Jujubae date, longan, cynamorlum herba cistanches, morinda officinalis, prepared fleeceflower root, carrot, boxthorn fruit, flos chrysanthemi indici, rhizoma batatatis, celery, peppermint, wheat flour, gardenia jasminoides, and fructus cnidii selinum are added into an automatic drying machine and dried at 110° C. for 30 minutes, and then taken out, placed into an automatic pulverizer together with the fried star anise and crushed into 250-300 mesh powders for reserving;

(3) the vegetable oil is poured into a jacketed pan and heated to 100° C.; then the reserved schisandrae fruit, coriander, brassica alba boiss, celery seed, cumin, white pepper, black pepper, onion, dried tangerine peel, semen trigonellae, myristica fragrans houttuyn, cinnamomum wilsonii gamble, cardamon, capsicum, flos caryophylli, rhizoma zingiberis, cuminum cyminum, fructus foeniculi, allium sativum, allspice, thymus, mustard, pericarpium zanthoxyli, radix angelicae dahuricae, turmeric, lentinus edodes, hericium erinaceus, ganoderma lucidum, fructus Jujubae date, longan, cynamorlum herba cistanches, morinda officinalis, prepared fleeceflower root, carrot, boxthorn fruit, flos chrysanthemi indici, rhizoma batatatis, celery, peppermint, wheat flour, gardenia jasminoides, and fructus cnidii selinum together with the fried star anise are added, and fried for 15 minutes; after the heating is ceased and the temperature is naturally cooled to 30° C., white granulated sugar, edible salt, sodium glutamate, disodium 5′-inosinate, citric acid, glycerol monostearate, tryptophan, defatted milk powder, coconut powder, honey, glucose, apple paste, hydrolyzed vegetable protein, L-lysine, taurine, multivariant high calcium, ferrous gluconate, zinc gluconate, soybean lecithin, red grape wine, tyrosine, methionine, glycine are added into the pan, stirred for 15 minutes, and then taken out, briquetted, packaged for the final product.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

What is claimed is:

1. A curry seasoning, which is characterized in that the formula thereof has following components:
schisandrae fruit 1-3%, star anise 1-3%, coriander 0.5-1.5%, brassica alba boiss 0.5-1.5%, celery seed 0.5-1.5%, cumin 0.5-1.5%, white pepper 0.5-1.5%, black pepper 0.5-1.5%, onion 0.5-1.5%, dried tangerine peel 0.5-1.5%, semen trigonellae 0.5-1.5%, myristica fragrans houttuyn 0.5-1.5%, cinnamomum wilsonii gamble 0.5-1.5%, cardamon 0.5-1.5%, capsicum 0.5-1.5%, flos caryophylli 0.5-1.5%, rhizoma zingiberis 0.5-1.5%, cuminum cyminum 0.5-1.5%, fructus foeniculi 0.5-1.5%, allium sativum 0.5-1.5%, allspice 0.5-1.5%, thymus 0.5-1.5%, mustard 0.5-1.5%, pericarpium zanthoxyli 1-3%, radix angelicae dahuricae 0.5-1.5%, turmeric 25-35%, lentinus edodes 0.5-1.5%, hericium erinaceus 0.5-1.5%, ganoderma lucidum 0.5-1.5%, fructus Jujubae date 0.5-1.5%, longan 0.5-1.5%, cynamorlum herba cistanches 0.5-1.5%, morinda officinalis 0.5-1.5%, prepared fleeceflower root 0.5-1.5%, carrot 0.5-1.5%, boxthorn fruit 0.5-1.5%, flos chrysanthemi indici 0.5-1.5%, rhizoma batatatis 0.5-1.5%, celery seed 0.5-1.5%, vegetable oil 2.5-3.5%, wheat flour 0.5-1.5%, disodium 5′-inosinate 0.5-1.5%, glycerol monostearate 2-4%, tryptophan 0.5-1.5%, defatted milk powder 0.5-1.5%, coconut powder 0.5-1.5%, honey 0.5-1.5%, glucose 0.5-1.5%, apple paste 0.5-1.5%, hydrolyzed vegetable protein 0.5-1.5%, L-lysine 0.5-1.5%, taurine 0.5-1.5%, peppermint 0.5-1.5%, multivariant high calcium 0.5-1.5%, ferrous gluconate 0.3-0.7%, zinc gluconate 0.3-0.7%, soybean lecithin 0.5-1.5%, red grape wine 0.5-1.5%, tyrosine 0.3-0.7%, methionine 0.3-0.7%, and glycine 0.3-0.7%,
provided that, after a final product is prepared using the raw materials in the above blending weight ratios, the sum of all components is 100% by weight.

2. A process for preparing a curry seasoning comprising star anise, characterized in that:
(1) the star anise is fried in an automatic frying pan at 155° C. for 23 minutes and then taken out of the frying pan and reserved;
(2) schisandrae fruit, coriander, brassica alba boiss, celery seed, cumin, white pepper, black pepper, onion, dried tangerine peel, semen trigonellae, myristica fragrans houttuyn, cinnamomum wilsonii gamble, cardamon, capsicum, flos caryophylli, rhizoma zingiberis, cuminum cyminum, fructus foeniculi, allium sativum, allspice, thymus, mustard, pericarpium zanthoxyli, radix angelicae dahuricae, turmeric, lentinus edodes, hericium erinaceus, ganoderma lucidum, fructus Jujubae date, longan, cynamorlum herba cistanches, morinda officinalis, prepared fleeceflower root, carrot, boxthorn fruit, flos chrysanthemi indici, rhizoma batatatis, celery, peppermint, wheat flour, gardenia jasminoides, fructus cnidii selinum are added into an automatic drying machine and dried at 110° C. for 30 minutes, and then taken out, placed into an automatic pulverizer together with the fried star anise and crushed into 250-300 mesh powder and reserved;
(3) vegetable oil is pored into a jacketed pan and heated to 100° C., after which the reserved schisandrae fruit, coriander, brassica alba boiss, celery seed, cumin, white pepper, black pepper, onion, dried tangerine peel, semen trigonellae, myristica fragrans houttuyn, cinnamomum wilsonii gamble, cardamon, capsicum, flos caryophylli, rhizoma zingiberis, cuminum cyminum, fructus foeniculi, allium sativum, allspice, thymus, mustard, pericarpium zanthoxyli, radix angelicae dahuricae, turmeric, lentinus edodes, hericium erinaceus, ganoderma lucidum, fructus Jujubae date, longan, cynamorlum herba cistanches, morinda officinalis, prepared fleeceflower root, carrot, boxthorn fruit, flos chrysanthemi indici, rhizoma batatatis, celery, peppermint, wheat flour, gardenia jasminoides, and fructus cnidii selinum together with the fried star anise are added and fried for 15 minutes;
(4) after the heating is ceased in step (3), the temperature cooled to 30° C. and then white granulated sugar, edible salt, sodium glutamate, disodium 5′-inosinate, citric acid, glycerol monostearate, tryptophan, defatted milk powder, coconut powder, honey, glucose, apple paste, hydrolyzed vegetable protein, L-lysine, taurine, multivariant high calcium, ferrous gluconate, zinc gluconate, soybean lecithin, red grape wine, tyrosine, methionine, and glycine are added into the pan, stirred for 15 minutes, and then taken out and briquetted to form the curry seasoning.
